(19) United States
(12) Patent Application Publication
(10) Pub. No.: US 2016/0363042 A1
(43) Pub. Date: Dec. 15, 2016

(54) COMBUSTION CHAMBER OF DIESEL ENGINE

(71) Applicant: Dalian University of Technology, Dalian (CN)

(72) Inventors: Wuqiang LONG, Dalian (CN); Shuang HE, Dalian (CN); Jiangping TIAN, Dalian (CN); Hua TIAN, Dalian (CN); Baoguo DU, Dalian (CN); Liyan FENG, Dalian (CN); Yao FU, Dalian (CN); Ping YI, Dalian (CN)

(21) Appl. No.: 15/245,215

(22) Filed: Aug. 24, 2016

Related U.S. Application Data
(63) Continuation-in-part of application No. PCT/CN2015/000103, filed on Feb. 16, 2015.

(30) Foreign Application Priority Data
Feb. 24, 2014 (CN) 201410061414.5

(51) Int. Cl. F02B 23/06

(52) U.S. Cl. CPC F02B 23/0624; F02B 23/0651; F02B 23/0669

(57) ABSTRACT

A combustion chamber of diesel engine. The diesel engine includes a cylinder head, a cylinder sleeve, and a piston. The cylinder head, the cylinder sleeve, and the piston form the combustion chamber. The combustion chamber includes a headspace; a central part; and a collision belt. The collision belt includes a collision surface, an upper guide surface, and a lower guide surface. The collision belt is configured to connect the headspace and the central part. The collision surface is an inclined surface, a convex surface, or a concave surface. The first tapered surface includes a second inclined surface, a second curved surface, and a third inclined surface; the second tapered surface includes a fourth inclined surface, a third curved surface, and a second concave surface; the first curved surface includes a second convex surface and a third concave surface.

### CROSS-REFERENCE TO RELATED APPLICATIONS

This application is a continuation-in-part of International Patent Application No. PCT/CN2015/000103 with an international filing date of Feb. 16, 2015, designating the United States, now pending, and further claims priority benefits to Chinese Patent Application No. 201410061414.5 filed Feb. 24, 2014. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a combustion chamber of diesel engine.

Description of the Related Art

Typically, the headspace of the combustion chamber in diesel engines has recesses, and a thick layer of mixed diesel-gas tends to accumulate in the recesses. As a result, the distribution of the mixed oil gas is uneven, the combustion of the diesel is incomplete, the fuel consumption is high, and a large amount of soot is produced.

### SUMMARY OF THE INVENTION

In view of the above-described problems, it is one objective of the invention to provide a combustion chamber of diesel engine. The shape of the combustion chamber is favorable to the even distribution of the oil mist from the fuel nozzle. In the combustion chamber, one part of the diesel oil mist rebounds from the collision belt and the diesel oil is atomized twice, and the other part of the diesel oil mist is distributed along the collision belt, thereby improving the atomization effect of the mist and expanding the space distribution of the mist. Increasing the height of the headspace of the combustion chamber can enable the diesel and the air to be mixed effectively and uniformly in the headspace.

To achieve the above objective, in accordance with one embodiment of the invention, there is provided a combustion chamber of diesel engine, the diesel engine comprising a cylinder head, a cylinder sleeve, and a piston; the cylinder head, the cylinder sleeve, and the piston forming the combustion chamber; the combustion chamber comprising: a headspace; a central part; and a collision belt; the collision belt comprising a collision surface, an upper guide surface, and a lower guide surface. The collision belt is configured to connect the headspace and the central part.

The headspace and the central part are separated by increasing a headspace height, adjusting a throat diameter, and providing the collision belt. The cylinder diameter is the diameter of the headspace. The fuel injector injects diesel oil mist on the collision belt, and one part of the diesel oil mist rebounds from the collision belt and the diesel oil mist is atomized twice, while the other part of the diesel oil mist is distributed along the collision belt towards the headspace and the central part, respectively, thus oil and air are uniformly mixed. The collision belt comprises a collision surface, an upper guide surface, and a lower guide surface.

In a class of this embodiment, the collision surface is a first inclined surface, a first convex surface, or a first concave surface. An inclined angle of the first inclined surface is adjusted according to an injection angle, so as to control a distribution proportion of diesel oil in the headspace and in the central part.

In a class of this embodiment, the collision surface is a first tapered surface, a second tapered surface, or a first curved surface. The first tapered surface comprises a second inclined surface, a second curved surface, and a third inclined surface. The second tapered surface comprises a fourth inclined surface, a third curved surface, and a second concave surface. The first curved surface comprises a second convex surface and a third concave surface.

In a class of this embodiment, the upper guide surface is a third convex surface or a first flat surface. The third convex surface is disposed higher than a top surface of the piston. The first flat surface is at an equal height as the top surface of the piston.

In a class of this embodiment, the lower guide surface is a second flat surface, a fourth curved surface, a first right-angled surface, or a fourth concave surface.

In a class of this embodiment, the top surface of the piston is a fifth inclined surface or a sixth inclined surface.

In a class of this embodiment, the top surface of the piston is a first guide surface comprising a fifth concave surface and a seventh inclined surface. The seventh inclined surface is disposed lower than the third convex surface.

In a class of this embodiment, the top surface of the piston is a second guide surface comprising a sixth concave surface and an eighth inclined surface. The eighth inclined surface is disposed higher than the third convex surface.

In a class of this embodiment, the top surface of the piston is a third guide surface comprising a first transitional surface, a ninth inclined surface, a second transitional surface, and a tenth inclined surface.

In a class of this embodiment, the central part has a W-shaped or a basin-shaped bottom surface.

Advantages of the combustion chamber according to embodiments of the invention are summarized as follows:

The combustion chamber of diesel engine is distributed to be two parts: the headspace and the central part. The collision belt is disposed between the headspace and the central part. The fuel injector injects diesel oil mist on the collision belt, and one part of the diesel oil mist rebounds from the collision belt and the diesel oil mist is atomized twice, and the other part of the diesel oil mist is distributed along the collision belt towards the headspace and the central part, respectively, thus the oil and the air are uniformly mixed. The combustion chamber expands the area and increases the speed of the mixture of the diesel oil and the air, enabling a relatively lean diffusion combustion in the combustion chamber, thereby decreasing the emission of soot and NOₓ, and effectively improving the combustion of diesel engine. Thus the combustion chamber is economical. At rated load, compared with a conventional system, the combustion chamber in the invention has the economy increased by 4%, the soot emission decreased by 50%, and the NOₓ emission decreased by 8%.

### BRIEF DESCRIPTION OF THE DRAWINGS

The invention is described hereinbelow with reference to the accompanying drawings, in which:

FIG. 1 is a schematic diagram of a combustion chamber of diesel engine in accordance with one embodiment of the invention;

FIG. 2 is an enlarged view taken from part A in FIG. 1 showing that a collision belt is a first inclined surface;

FIG. 3 is a schematic diagram showing that a collision surface is a first convex surface in accordance with one embodiment of the invention;

FIG. 4 is a schematic diagram showing that a collision surface is a first concave surface in accordance with one embodiment of the invention;

FIG. 5 is a schematic diagram showing that a collision surface is a first tapered surface in accordance with one embodiment of the invention;

FIG. 6 is a schematic diagram showing that a collision surface is a second tapered surface in accordance with one embodiment of the invention;

FIG. 7 is a schematic diagram showing that a collision surface is a first curved surface in accordance with one embodiment of the invention;

FIG. 8 is a schematic diagram showing that an upper guide surface is a first flat surface, and a lower guide surface is a second flat surface in accordance with one embodiment of the invention;

FIG. 9 is a schematic diagram showing that a lower guide surface is a fourth curved surface in accordance with one embodiment of the invention;

FIG. 10 is a schematic diagram showing that a lower guide surface is a first right-angled surface in accordance with one embodiment of the invention;

FIG. 11 is a schematic diagram showing that a lower guide surface is a fourth concave surface in accordance with one embodiment of the invention;

FIG. 12 is an enlarged view taken from part B in FIG. 1 showing that a top surface of the piston is a fifth inclined surface;

FIG. 13 is a schematic diagram showing that a top surface of the piston is a sixth inclined surface in accordance with one embodiment of the invention;

FIG. 14 is a schematic diagram showing that a top surface of the piston is a first guide surface in accordance with one embodiment of the invention;

FIG. 15 is a schematic diagram showing that a top surface of the piston is a second guide surface in accordance with one embodiment of the invention;

FIG. 16 is a schematic diagram showing that a top surface of the piston is a third guide surface in accordance with one embodiment of the invention;

FIG. 17 is a schematic diagram showing that a central part of a combustion chamber has a basin-shaped bottom surface.

In the drawings, the following reference numbers are used: 1. Cylinder head; 2. Cylinder sleeve; 3. Piston; 4. Combustion chamber; 5. Fuel injector; 6. Beams of diesel oil mist; 7. Headspace; 8. Central part; 9. Collision belt; 10. Third convex surface; 11. First inclined surface; 12. First convex surface; 13. First concave surface; 14. First tapered surface; 14a. Second inclined surface; 14b. Second curved surface; 14c. Third inclined surface; 15. Second tapered surface; 15a. Fourth inclined surface; 15b. Third curved surface; 15c. Second concave surface; 16. First curve surface; 16a. Second convex surface; 16b. Third concave surface; 17. First flat surface; 18. Second flat surface; 19. Fourth curved surface; 20. First right-angled surface; 21. Fourth concave surface; 22. Fifth inclined surface; 23. Sixth inclined surface; 24. First guide surface; 24a. Fifth concave surface; 24b. Seventh inclined surface; 25. Second guide surface; 25a. Sixth concave surface; 25b. Eighth inclined surface; 26. Third guide surface; 26a. First transitional surface; 26b. Ninth inclined surface; 26c. Second transitional surface; 26d. Tenth inclined surface; 27. W-shaped bottom surface; and 28. Basin-shaped bottom surface.

### DETAILED DESCRIPTION OF THE EMBODIMENTS

For further illustrating the invention, experiments detailing a combustion chamber of diesel engine are described below. It should be noted that the following examples are intended to describe and not to limit the invention.

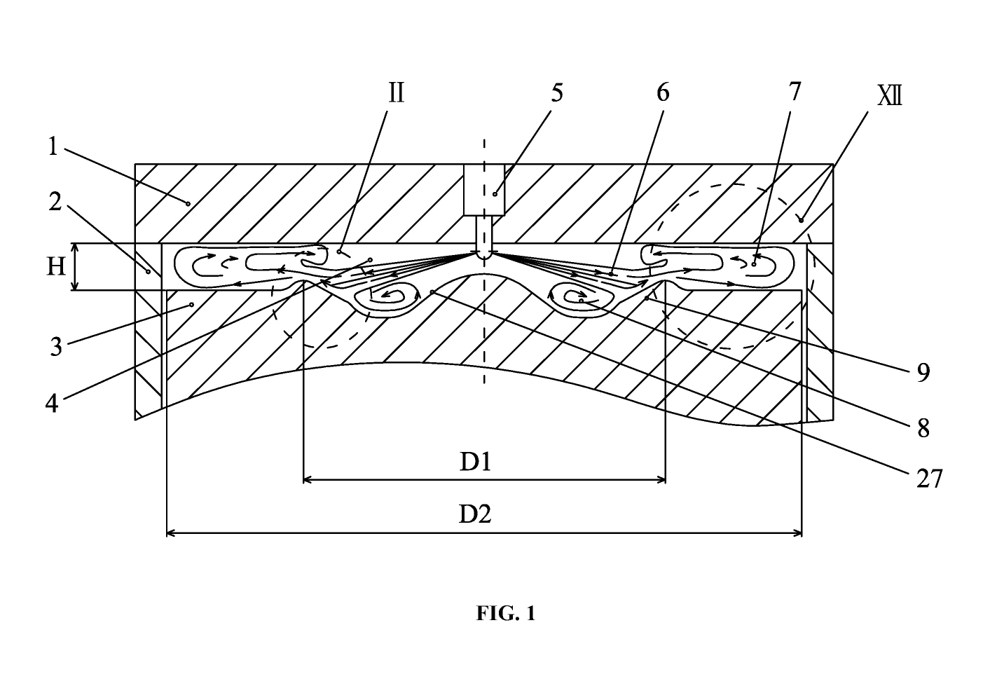

FIG. 1 is a schematic diagram of a combustion chamber of diesel engine in accordance with one embodiment of the invention. As shown in FIG. 1, the diesel engine comprises a cylinder head 1, a cylinder sleeve 2, a piston 3, a combustion chamber 4, a fuel injector 5, and a collision belt 9. The fuel injector 5 injects multiple beams of high pressure diesel oil in the form of mist in the combustion chamber 4. The combustion chamber comprises a headspace 7 and a central part 8. The headspace 7 and the central part 8 are distributed by increasing a headspace height H, adjusting a throat diameter D1, and providing a collision belt. The collision belt is configured to connect the headspace and the central part. A cylinder diameter D2 is a diameter of the headspace 7. The fuel injector 5 injects beams of diesel oil mist 6 on the collision belt 9, and one part of the diesel oil mist rebounds from the collision belt and the diesel oil mist is atomized twice, while the other part of the diesel oil mist is distributed along the collision belt 9 towards the headspace 7 and the central part 8, respectively, thus the oil and the air are uniformly mixed. The collision belt 9 comprises a collision surface, an upper guide surface, and a lower guide surface.

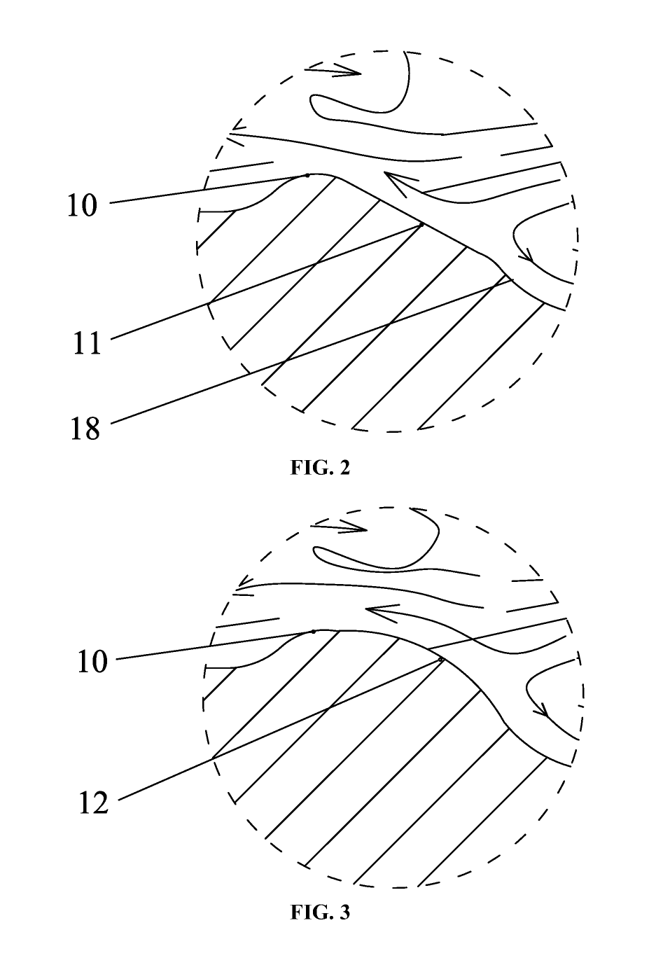

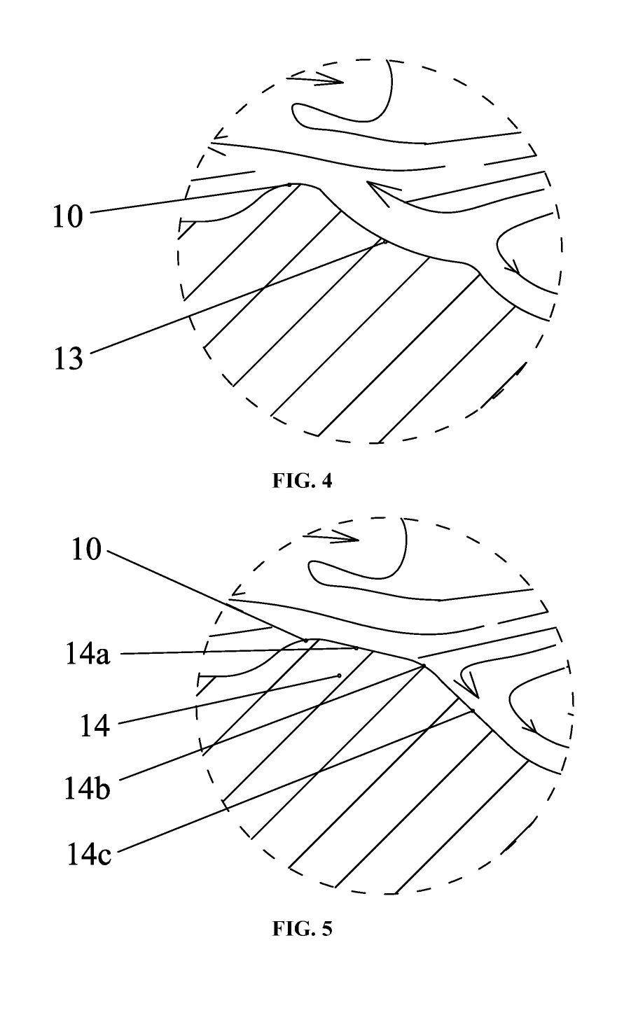

FIGS. 2-4 are schematic diagrams of three types of collision surfaces. The collision surface is a first inclined surface 11, a first convex surface 12, or a first concave surface 13. A third convex surface 10 is corresponding to an inclined angle of the first inclined surface 11, the first convex surface 12, and the first concave surface 13. An injection angle of the diesel oil mist 6 injected by the fuel injector 5 is adjusted correspondingly, so as to control a distribution proportion of diesel oil in the headspace 7 and in the central part 8.

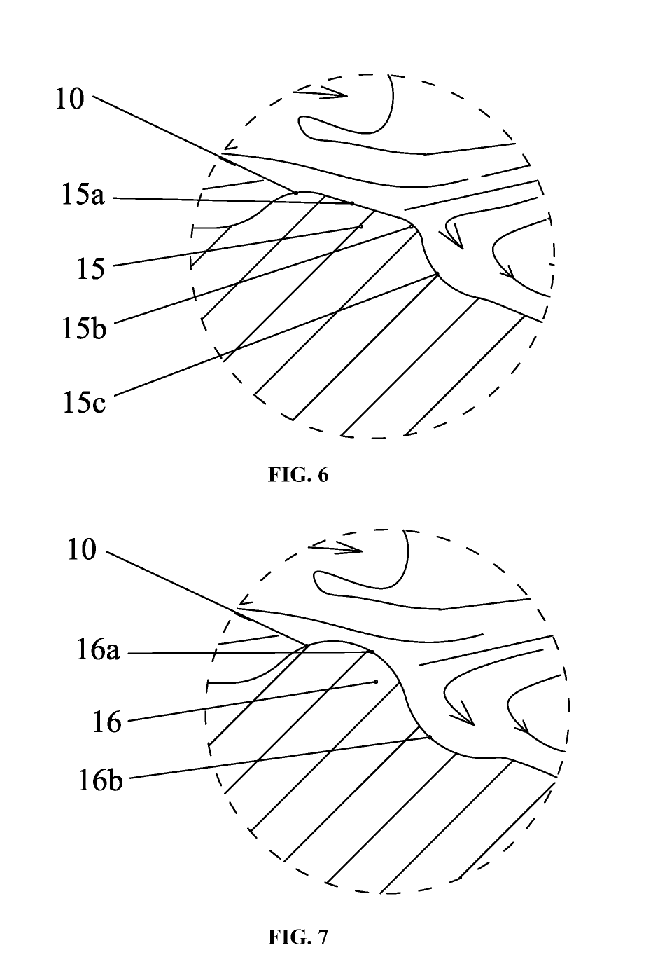

FIGS. 5-7 are schematic diagrams of another three types of collision surfaces. The collision surface is a first tapered surface 14, a second tapered surface 15, or a first curved surface 16. The first tapered surface 14 comprises a second inclined surface 14a, a second curved surface 14b, and a third inclined surface 14c. The second tapered surface 15 comprises a fourth inclined surface 15a, a third curved surface 15b, and a second concave surface 15c. The first curved surface 16 comprises a second convex surface 16a and a third concave surface 16b. The injection angle of the diesel oil mist 6 injected by the fuel injector 5 on the first tapered surface 14, the second tapered surface 15, or the first curved surface 16 is adjusted correspondingly, so as to control a distribution proportion of diesel oil in the headspace 7 and in the central part 8.

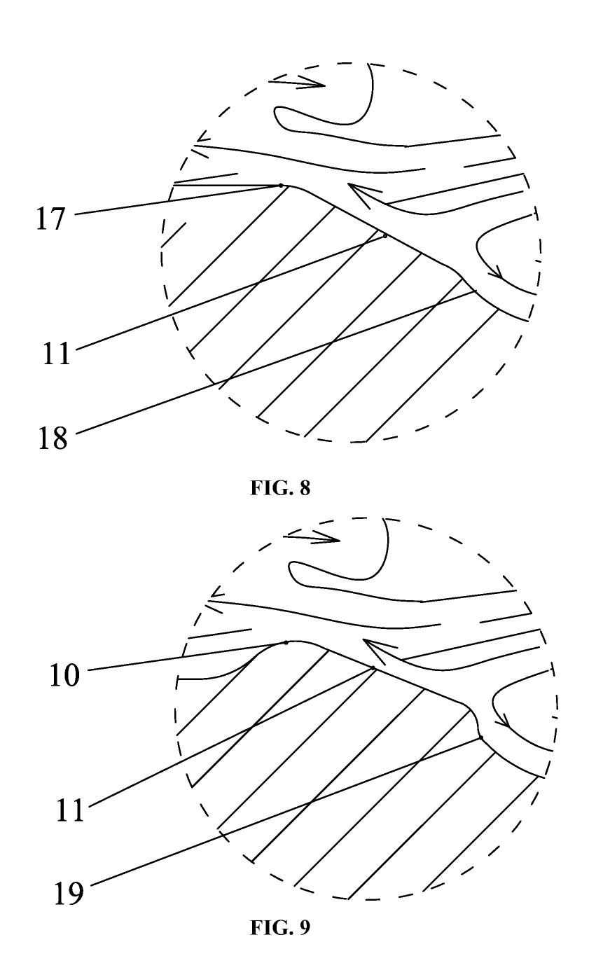

FIGS. 8-9 are schematic diagrams of upper guide surfaces. The upper guide surface is a third convex surface 10 or a first flat surface 17. The third convex surface 10 is disposed higher than a top surface of the piston. The first flat surface 17 is at an equal height as the top surface of the piston. The injection angle of the diesel oil mist 6 injected by the fuel injector 5 on the first inclined surface 11 is adjusted correspondingly, so as to control a distribution proportion of diesel oil in the headspace 7 and in the central part 8.

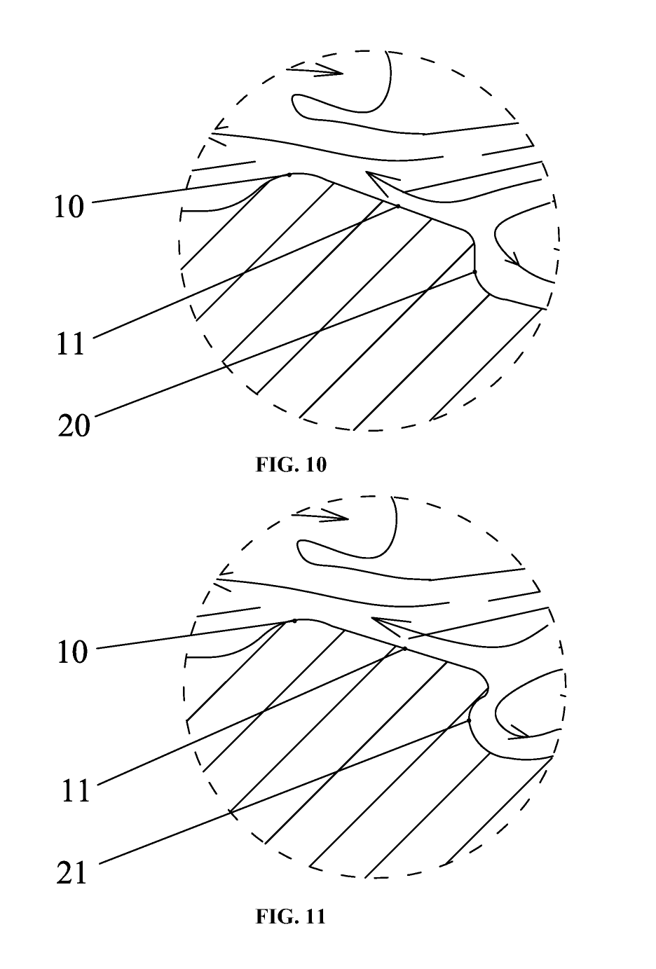

FIGS. 2, 8, 9, 10,11 are schematic diagrams of lower guide surfaces. The lower guide surface is a second flat surface 18, a fourth curved surface 19, a first right-angled surface 20, or a fourth concave surface 21. The injection angle of the diesel oil mist 6 injected by the fuel injector 5 on the first inclined surface 11 is adjusted correspondingly, so as to control a distribution proportion of diesel oil in the headspace 7 and in the central part 8.

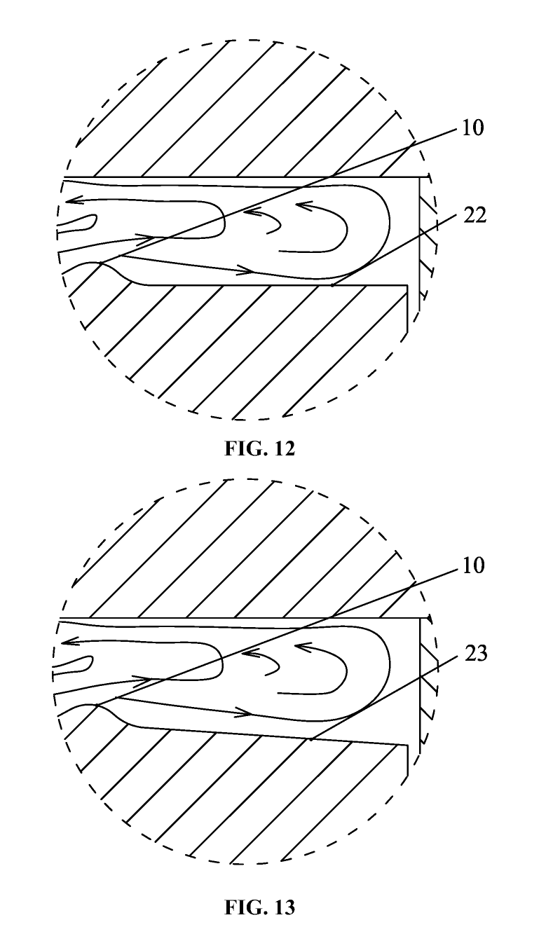

FIGS. 12-13 are schematic diagrams of top surfaces of piston. The top surface of the piston is a fifth inclined surface 22 or a sixth inclined surface 23, so that the diesel oil mist in the headspace 7 is quickly mixed and forms the uniformly mixed gas.

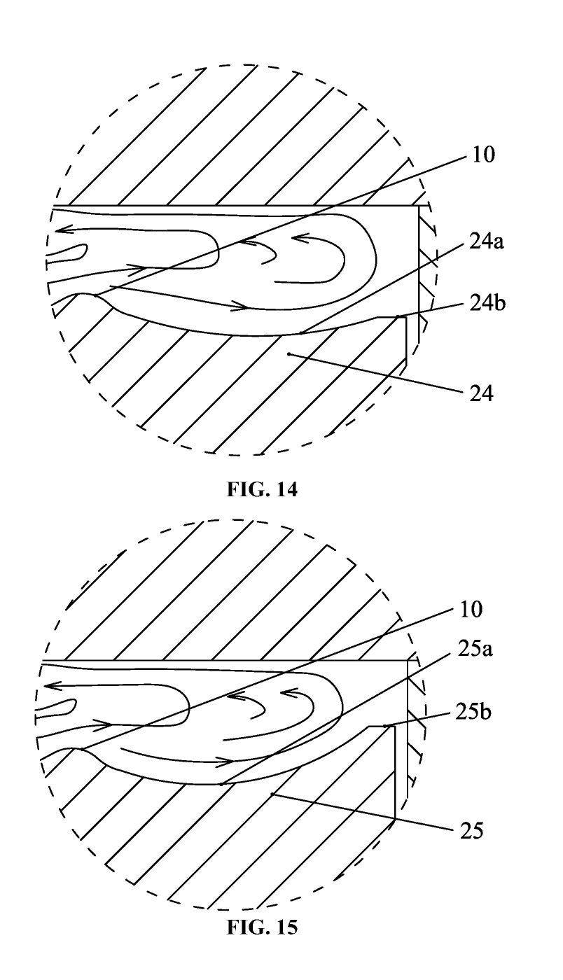

FIG. 14 is a schematic diagram showing that the top surface of the piston is a first guide surface. The top surface of the piston is the first guide surface 24 comprising a fifth concave surface 24a and a seventh inclined surface 24b. The seventh inclined surface 24b is disposed lower than the third convex surface 10, so that the diesel oil mist in the headspace 7 is quickly mixed and forms the uniformly mixed gas.

FIG. 15 is a schematic diagram showing that the top surface of the piston is a second guide surface. The top surface of the piston is the second guide surface 25 comprising a sixth concave surface 25a and an eighth inclined surface 25b. The eighth inclined surface 25b is disposed higher than the third convex surface 10, so that the diesel oil mist in the headspace 7 is quickly mixed and forms the uniformly mixed gas.

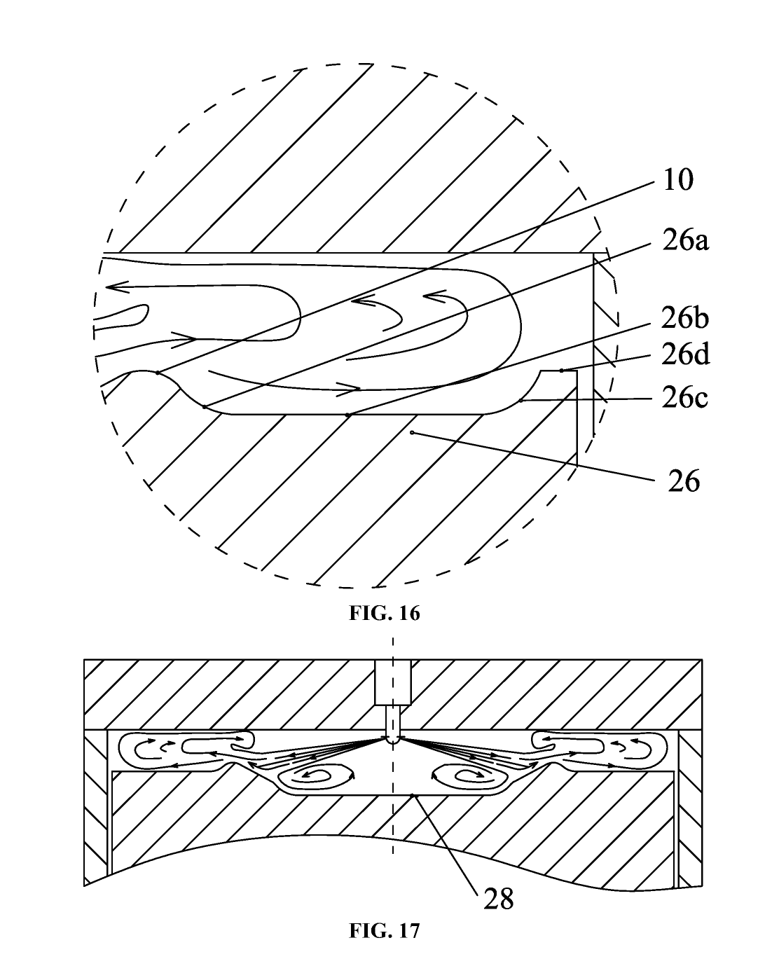

FIG. 16 is a schematic diagram showing that the top surface of the piston is a third guide surface. The top surface of the piston is the third guide surface 26 comprising a first transitional surface 26a, a ninth inclined surface 26b, a second transitional surface 26c, and a tenth inclined surface 26d, so that the diesel oil mist in the headspace 7 is quickly mixed and forms the uniformly mixed gas.

FIG. 17 is a schematic diagram showing that a central part of a combustion chamber has a basin-shaped bottom surface 28.

The collision belt of the combustion chamber is designed to have the following six types of collision surfaces:

(1) The collision surface is an inclined surface.

(2) The collision surface is a convex and curved surface;

(3) The collision surface is a concave and curved surface;

(4) The collision surface comprises two tapered surfaces, and the transitional surface between the two tapered surfaces is smooth.

(5) The collision surface comprises an inclined surface and a concave and curved surface; the transitional surface between the inclined surface and the concave and curved surface is smooth.

(6) The collision surface comprises a convex and curved surface and a concave and curved surface; the transitional surface between the convex and curved surface and the concave and curved surface is smooth.

Optionally, the upper guide surface is a convex surface or a flat surface. The convex surface is disposed higher than the top surface of the piston. The flat surface is at an equal height as the top surface of the piston.

Optionally, the lower guide surface is a flat surface, a curved surface, a right-angled arc surface, or a concave surface.

The top surface of the piston is designed to have the following five types of guide surfaces:

(1) The guide surface is an inclined surface.

(2) The guide surface comprises a concave and curved surface and an inclined surface; the inclined surface is disposed lower than the convex surface of the upper guide surface.

(3) The guide surface comprises a concave and curved surface and an inclined surface; the inclined surface is disposed higher than the convex surface of the upper guide surface.

(4) The guide surface comprises a basin-shaped surface and an inclined surface.

Optionally, the central part has a W-shaped or a basin-shaped bottom surface.

The different bottom surfaces of the central part facilitate different airflow motion, enabling the combustion chamber to be applied to different diesel engines and different working conditions.

Different collision surfaces are combined with the upper and lower guide surfaces to form different collision belts.

Different collision belts are combined with different guide surfaces of the top surface to form different combustion chambers.

The fuel injector injects diesel oil mist on the collision belt, and one part of the diesel oil mist rebounds from the collision belt and the diesel oil mist is atomized twice, while the other part of the diesel oil mist is distributed along the collision belt. The upper guide surface, the lower guide surface, and the guide surface of the top surface are adapted to guide the airflow in the cylinder, increase the disturbance in the cylinder, promote the tumble motion, and improve the air entrainment. The combustion chamber enables the diesel oil mist to be quickly distributed and atomized, meanwhile expands the headspace of the diesel engine, so that the mixed gas quickly becomes uniform, and the air utilization rate is improved.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A combustion chamber of diesel engine, the diesel engine comprising a cylinder head, a cylinder sleeve, and a piston; the cylinder head, the cylinder sleeve, and the piston forming the combustion chamber; the combustion chamber comprising:
a headspace;
a central part; and
a collision belt; the collision belt comprising a collision surface, an upper guide surface, and a lower guide surface;
wherein
the collision belt is configured to connect the headspace and the central part;
the collision surface is a first inclined surface, a first convex surface, or a first concave surface; an inclined angle of the first inclined surface is adjusted according to an injection angle of oil mist to control a distribution proportion of diesel oil in the headspace and in the central part; or, the collision surface is a first tapered surface, a second tapered surface, or a first curved surface; the first tapered surface comprises a second inclined surface, a second curved surface, and a third inclined surface; the second tapered surface comprises a fourth inclined surface, a third curved surface, and a second concave surface; the first curved surface comprises a second convex surface and a third concave surface;
the upper guide surface is a third convex surface or a first flat surface; the third convex surface is disposed higher than a top surface of the piston; the first flat surface is at an equal height as the top surface of the piston; and
the lower guide surface is a second flat surface, a fourth curved surface, a first right-angled surface, or a fourth concave surface.

2. The combustion chamber of claim 1, wherein the top surface of the piston is a fifth inclined surface or a sixth inclined surface.

3. The combustion chamber of claim 1, wherein the top surface of the piston is a first guide surface comprising a fifth concave surface and a seventh inclined surface; the seventh inclined surface is disposed lower than the third convex surface.

4. The combustion chamber of claim 1, wherein the top surface of the piston is a second guide surface comprising a sixth concave surface and an eighth inclined surface; the eighth inclined surface is disposed higher than the third convex surface.
